(19) United States
(12) Patent Application Publication
(10) Pub. No.: US 2020/0278718 A1
(43) Pub. Date: Sep. 3, 2020

(54) WEARABLE COMPUTING DEVICE MOUNTS WITH DOCKING STATIONS

(71) Applicant: HEWLETT-PACKARD DEVELOPMENT COMPANY, L.P., Spring, TX (US)

(72) Inventors: Steven Steinmark, Fort Collins, CO (US); Nathan Barr Nuber, Fort Collins, CO (US); Robert Paul Martin, Fort Collins, CO (US)

(73) Assignee: HEWLETT-PACKARD DEVELOPMENT COMPANY, L.P., Spring, TX (US)

(21) Appl. No.: 16/762,624

(22) PCT Filed: Nov. 8, 2017
(86) PCT No.: PCT/US2017/060533

§ 371 Date: May 8, 2020

(51) Int. Cl. G06F 1/16; A41D 1/00

(52) U.S. Cl. CPC G06F 1/163; G06F 1/1632; A41D 1/005

(57) ABSTRACT

In one example in accordance with the present disclosure, a wearable computing device mount is described. The wearable mount includes a harness wearable by a user and a plate attached to the harness, A computing device is selectively mounted to the plate via mechanical fasteners. The mount also includes a docking station coupled to the plate. The docking station includes a computing device port to engage with an electrical connector of the computing device when mounted to the plate and an auxiliary port to receive an auxiliary component wherein the docking station electrically couples the computing device with the auxiliary component.

### BACKGROUND

Enhanced reality systems allow a user to become immersed in an enhanced reality environment wherein they can interact with the enhanced environment. For example, a head-mounted display, using stereoscopic display devices, allows a user to see, and become immersed in, any desired virtual scene. Such enhanced reality applications also provide visual stimuli, auditory stimuli, and can track user movement to create a rich immersive experience.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a wearable computing device mount, according to an example of the principles described herein.

FIG. 2 is a front view of a user wearing the wearable computing device mount, according to an example of the principles described herein.

FIG. 3 is a back view of a user wearing the wearable computing device mount, according to an example of the principles described herein.

FIG. 4 is a back view of a user wearing the wearable computing device mount with a computing device inserted therein, according to an example of the principles described herein.

FIG. 5 is a back view of a user wearing the wearable enhanced reality system, according to an example of the principles described herein.

FIG. 6 is a top view of the electrical connector of the wearable computing device mount, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description: however, the description is not limited to the examples and/or implementations provided in the drawings.

### DETAILED DESCRIPTION

Enhanced reality systems allow a user to become immersed in an enhanced reality environment wherein they can interact with the enhanced environment. For example, a head-mounted display, using stereoscopic display devices, allows a user to see, and become immersed in, any desired virtual scene. Such virtual reality applications also provide visual stimuli, auditory stimuli, and can track user movement to create a rich immersive experience. In some examples, user input devices are incorporated into an enhanced reality system. For example, handles that have various gyroscopes, accelerometers, and buttons, detect user movement and other user input and manipulate the enhanced environment accordingly. As such, users can use input devices to interact with the enhanced scene. As one particular example, hand trackers in the handles allow a user to grab objects in the enhanced scene,

Enhanced reality systems include virtual reality (VR) systems, augmented reality (AR) systems, and mixed reality (MR) systems. Such enhanced reality systems can include enhanced reality headsets to generate realistic images, sounds, and other human discernable sensations that simulate a user's physical presence in a virtual environment presented at the headset. A VR system includes physical spaces and/or multi-projected environments. AR systems may include those systems and devices that implement live direct and/or indirect displays of a physical, real-world environment whose elements are augmented by computer-generated sensory input such as sound, video, graphics and/or GPS data. MR systems merge real and virtual worlds to produce new environments and visualizations where physical and digital objects co-exist and interact in real time. For simplicity, VR systems, AR systems, and MR systems are referred to herein as enhanced reality systems.

While such enhanced reality systems have undoubtedly provided a valuable tool in many industries as well as a source of diversion for users, some characteristics impede their more complete implementation. For example, large amounts of data are transferred between 1) a computing device that generates the enhanced scene and 2) the auxiliary components, such as enhanced reality headsets and enhanced reality controllers, which allow interaction with the scene. To enhance information exchange, this data can be transferred via a physical cable tethered between the enhanced reality auxiliary components and the computing device. When one end of a physical cable is coupled to an immobile computing device such as a desktop, the user is limited in their movement by the dimensions of the cable, i.e., length of the physical cable.

Accordingly, the present specification describes a wearable mount that allows the computing device to move with the user, thus avoiding the limitations imposed by a length of physical cable. More specifically, the present specification describes a mount to which the computing device is selectively attached. The mount can then be worn by a user, on the back for example. To operate, the auxiliary components are electrically coupled to the computing device. However, rather than being directly coupled to the computing device, the mount includes a docking station to which the auxiliary components are connected. Upon insertion of the computing device into the docking station of the mount, an electrical connection is established between the computing device and the docking station. The connection works in combination with existing connections between the auxiliary components and the docking station, allowing the docking station to serve as a bridge between the computing device and the auxiliary components. In other words, rather than attaching the computing device to the wearable mount and then individually attaching each auxiliary component to the computing device, which can be time-consuming, inefficient, and burdensome; the auxiliary components can be coupled to the docking station.

Such a mount simplifies use of an enhanced reality system. Specifically, to be fully immersed in an enhanced environment, a user should be able to move around unrestricted. The wearable mount on which the computing device is placed facilitates such unimpeded movement. Moreover, the mount facilitates a truly mobile computing device by allowing selective removal of the computing device such that it can be relocated between the wearable mount and another docking port, the second docking port being already connected to a different variety of auxiliary components. For example, some auxiliary components associated with a desktop, e.g., a mouse, a keyboard, and/or a monitor, may be better suited for some workflows such as content creator workflows. By comparison, the accessories associated with consuming content within an enhanced environment are different, e.g., a head-mounted display and motion controllers. The docking station allows for a rapid transition between these two sets of accessories, thereby reducing the time between content creation and content viewing.

The docking station of the mount further enhances the mobility of the computing device as each auxiliary component, of which there may be many, is not attached to the computing device each time the computing device is inserted, but can rather be connected to a docking station of the mount. Accordingly, the computing device electrical connection can be at a single point or at multiple points, i.e., between the docking station of the mount and the computing device itself.

Specifically, the present specification describes a wearable computing device mount. The wearable computing device mount includes a harness wearable by a user and a plate attached to the harness. A computing device is selectively mounted to the plate via mechanical fasteners. The wearable computing device mount also includes a docking station attached to the plate. The docking station includes 1) a computing device port to engage with an electrical connector of the computing device when mounted to the plate and 2) an auxiliary port to receive an auxiliary component. The docking station electrically couples the computing device with the auxiliary component.

The present specification also describes a wearable computing system. The system includes a computing device and a wearable computing device mount. The wearable computing device mount includes a harness wearable by a user and a plate attached to the harness. A computing device is selectively mounted to the plate via mechanical fasteners. The wearable computing device mount also includes a docking station attached to the plate. The docking station includes a computing device port to engage with an electrical connector of the computing device when mounted to the plate. The docking station electrically couples the computing device with the auxiliary component.

The present specification also describes a wearable enhanced reality system, The system includes an enhanced reality computing device which generates an enhanced reality environment. The wearable enhanced reality system also includes a wearable computing device mount that includes a harness wearable by a user and a plate attached to the harness. The enhanced reality computing device is selectively mounted to the plate via mechanical fasteners. The wearable computing device mount also includes a docking station attached to the plate. The docking station includes 1) a computing device port to engage with an electrical connector of the computing device when mounted to the plate and establish an electrical connection with the enhanced reality computing device upon mounting to the plate and 2) multiple auxiliary ports, each to receive one of multiple auxiliary components. The system also include multiple auxiliary components comprising at least 1) a head-mounted enhanced reality display and 2) a computing device power supply.

In summary, using such a wearable computing device mount 1) improves immersion in the enhanced environment by allowing unimpeded movement of a user while interacting with the enhanced environment, 2) enhances the efficiency of use of an enhanced reality system by reducing the time between content creation and content viewing; and 3) simplifies the setup for the enhanced reality system. However, it is contemplated that the devices disclosed herein may address other matters and deficiencies in a number of technical areas.

As used in the present specification and in the appended claims, the term “a number of” or similar language is meant to be understood broadly as any positive number including 1 to infinity.

In the following description, for purposes of explanation, numerous specific details are set forth in order to provide a thorough understanding of the present systems and methods, It will be apparent, however, to one skilled in the art that the present apparatus, systems, and methods may be practiced without these specific details. Reference in the specification to “an example” or similar language means that a particular feature, structure, or characteristic described in connection with that example is included as described, but may or may not be included in other examples.

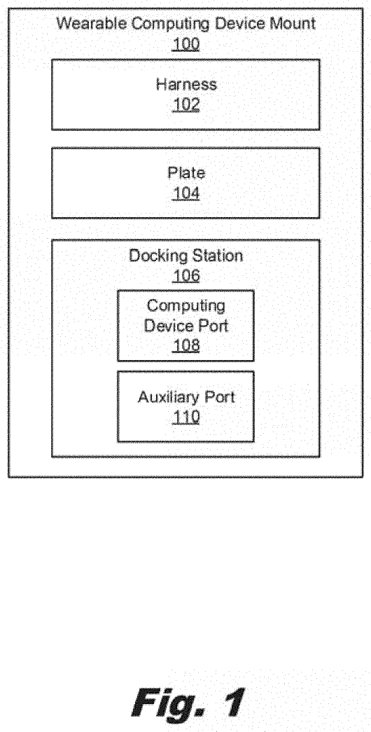

FIG. 1 is a block diagram of a wearable computing device mount (100), according to an example of the principles described herein. The wearable computing device mount (100) is to receive a computing device, which may be of a variety of types. For example, the computing device may be an enhanced reality computing device that generates an enhanced environment such as a virtual environment, a mixed environment, and/or an augmented environment. As will be described below, different auxiliary components may be coupled to the computing device to immerse a user in the enhanced environment. Specific examples of auxiliary components include an enhanced reality display device in the form of wearable goggles, an enhanced reality auditory device, and enhanced reality controllers can all be coupled to the computing device to create, and allow interaction with, the enhanced environment.

The wearable computing device mount (100) includes a harness (102) wearable by a user. For example, the harness (102) may include shoulder straps to be worn by a user. The harness (102) may be such that, when worn by a user, the computing device is disposed on a back of the user.

The wearable computing device mount (100) also includes a plate (104) that is attached to the harness (100). The plate (104) may be a rigid piece of material, such as plastic or metal, to which the computing device is attached. For example, the plate (104) may include a number of mechanical fasteners that interface with elements of the computing device to affix the two together. As a specific example, the mechanical fasteners of the plate (104) may be protrusions with hooks that interface with slots on the computing device.

The wearable computing device mount (100) also includes a docking station (106). The docking station (106) electrically couples the computing device to various auxiliary components. The docking station (106) may be passive, meaning it does not include processors or other data-processing components. In this example, the docking station (106) is a conduit for electrical signals and other data between the auxiliary components and the computing device. In another example, the docking station (106) is active, meaning it has processors or other signal-processing components to manipulate the data and other signals passing between the computing device and auxiliary components.

The docking station (106) includes a computing device port (108) that receives a computing device. Specifically, the computing device port (108) includes electrical components that engage with an electrical connector of the computing device upon mounting to the plate (104). Accordingly, an electrical connection between the docking station (104) and computing device is achieved once the computing device is seated against the plate (104) and no additional operations are performed to establish an electrical connection.

The docking station (106) also includes an auxiliary port (110). The auxiliary port (110) couples an auxiliary component to the computing device. For example, the docking station (106) may include a USB port to receive a connector for an enhanced reality controller. In this fashion, rather than connecting the enhanced reality controller to the computing device itself, it is connected to the docking station (106), thus allowing the computing device to be removed from, and attached to, the plate (104) without having to attach and detach the auxiliary components each time. In other words, the docking station (106) of the mount (100) allows a user to leave the auxiliary components, such as batteries and enhanced reality headsets, plugged into the mount (100) while the computing device is removed and attached. Doing so increases the technical ability of the system by providing an enhanced reality system that 1) is wearable and 2) provides for electrical connections through a wearable docking station (106) as opposed to through the computing device directly.

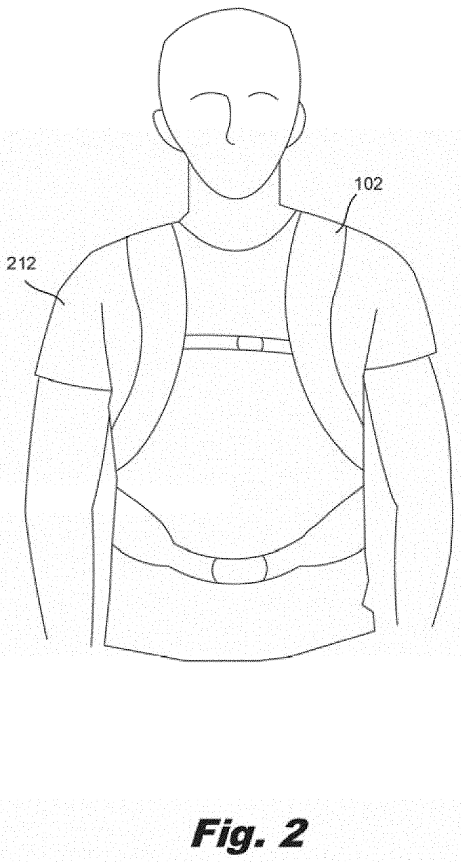

FIG. 2 is a front view of a user (212) wearing the wearable computing device mount (FIG. 1, 100), according to an example of the principles described herein. As described above, the wearable computing device mount (FIG. 1, 100) includes a harness (102) wearable by a user (212). Specifically, the harness (102) positions the plate (FIG. 1, 104) on a back of the user (212). Accordingly, the harness (102) may include shoulder straps to be placed on the shoulders of a user (212). A number of straps across the front of the user (212) secure the harness (102), and corresponding plate (FIG. 1, 104) and computing device, in place such that they do not fall off the user (212), which may potentially damage the computing device. Such shoulder straps and front straps may be formed of any material including nylon and may include padding for the comfort of the user (102). The harness (102) may be adjustable such that it can accommodate various shapes and sizes of users (212).

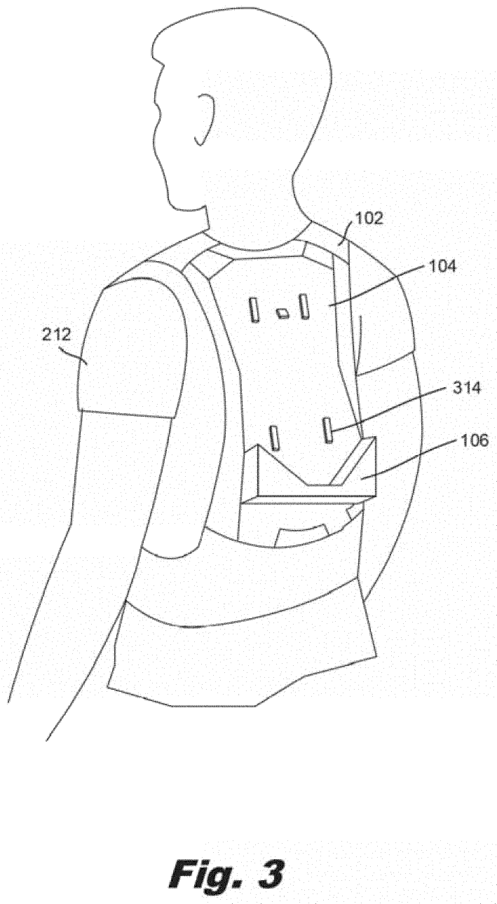

FIG. 3 is a back view of a user (212) wearing the wearable computing device mount (FIG. 1, 100), according to an example of the principles described herein. As described above, the wearable computing device mount (FIG. 1, 100) includes a harness (102) to be worn by the user (212). A plate (104) is attached to the harness (102). The harness (102) positions the plate (104), and the computing device when affixed, on the back of the user (212). The plate (104) may be formed of a rigid material to support the computing device. The plate (104) also includes a number of mechanical fasteners (314) disposed thereon to mechanically retain the computing device to the plate (104) and harness (102). For simplicity in FIG. 3, just one of the mechanical fasteners (314) is indicated with a reference number. The mechanical fasteners (314) may take any form. For example, the mechanical fasteners (314) may be interlocking slides that interface with slots on the computing device. While FIG. 3 depicts a particular orientation and configuration of mechanical fasteners (314), different orientations, configurations, and types of mechanical fasteners (314) may be used.

Also as described above, the wearable computing device mount (100) includes a docking station (106) to simplify electrical connection of a computing device and auxiliary components. That is, rather than having to connect each individual auxiliary component to the computing device, the auxiliary components can be attached to, and left attached to, the docking station (106). Then, when a user (212) desires to use the wearable computing device mount (FIG. 1, 100), the computing device is inserted to engage with the docking station (106). This engagement couples each auxiliary component to the computing device. Accordingly, for each use, rather than attaching multiple electrical connections, a single computing device-to-docking station (106) connection is made. The docking station (106) may be formed of any material including plastic and in some cases is selectively removable from the plate (104). That is, the docking station (106) may be removed from the harness (102). In other examples, the docking station (106) may be integrally formed with the plate (104). Doing so may reduce the complexity and weight of the wearable computing device mount (FIG. 1, 100).

As can be seen in FIG. 3, in some examples, the docking station (106) is disposed below the plate (104). However, other orientations are possible, for example with the docking station (106) disposed on a side of the plate (104).

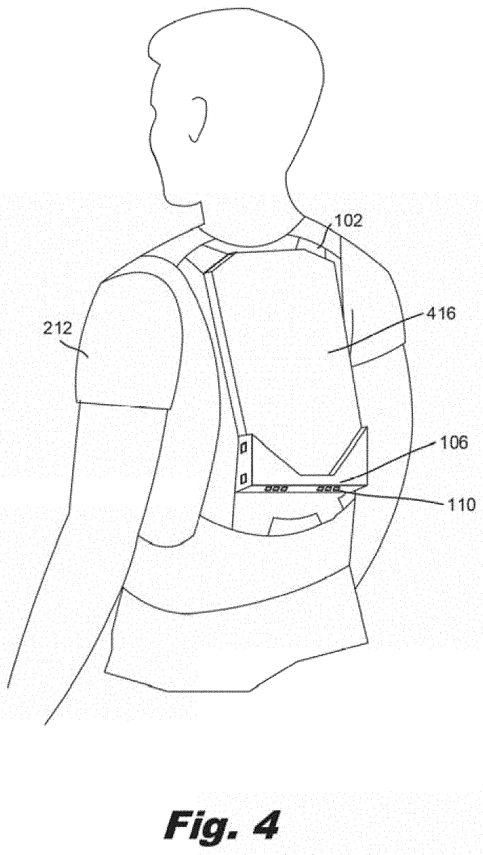

FIG. 4 is a back view of a user (212) wearing the wearable computing device mount (FIG. 1, 100) with a computing device (416) inserted therein, according to an example of the principles described herein. To achieve its desired functionality, the computing device (416) may include various hardware components. Specifically, the computing device (416) may be an enhanced reality computing device (416) and may include various hardware components to generate an enhanced reality environment.

Among these hardware components may be a number of processors which may include graphics processors, a number of data storage devices, a number of peripheral device adapters and a number of network adapters. These hardware components may be interconnected through the use of a number of busses and/or network connections. In one example, the processor, data storage device, peripheral device adapters, and a network adapter may be communicatively coupled via a bus.

The processor may include the hardware architecture to retrieve executable code from the data storage device and execute the executable code. The executable code may, when executed by the processor, cause the processor to implement at least the functionality of creating and interacting with an enhanced environment. In the course of executing code, the processor may receive input from and provide output to a number of the remaining hardware units.

The data storage device may store data such as executable program code that is executed by the processor or other processing device. As will be discussed, the data storage device may specifically store computer code representing a number of applications that the processor executes to implement at least the functionality described herein.

The data storage device may include various types of memory modules, including volatile and nonvolatile memory. For example, the data storage device of the present examples may include Random Access Memory (RAM), Read Only Memory (ROM), and Hard Disk Drive (HDD) memory. Many other types of memory may also be utilized, and the present specification contemplates the use of many varying type(s) of memory in the data storage device as may suit a particular application of the principles described herein. In certain examples, different types of memory in the data storage device may be used for different data storage needs. For example, in certain examples the processor may boot from Read Only Memory (ROM), maintain nonvolatile storage in the Hard Disk Drive (HDD) memory, and execute program code stored in Random Access Memory (RAM).

Generally, the data storage device may include a computer readable medium, a computer readable storage medium, or a non-transitory computer readable medium, among others. For example, the data storage device may be, but not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store computer usable program code for use by or in connection with an instruction execution system, apparatus, or device. In another example, a computer readable storage medium may be any non-transitory medium that can contain, or store a program for use by or in connection with an instruction execution system, apparatus, or device.

The hardware adapters in the computing device (416) enable the processor to interface with various other hardware elements, external and internal to the computing device (416). For example, the peripheral device adapters may provide an interface to input/output devices, such as, for example, enhanced reality display devices and enhanced reality controllers. The peripheral device adapters may also provide access to other external devices such as an external storage device.

As described above, the computing device (416) includes components that interface with the mechanical fasteners (FIG. 3, 314), such that the computing device (416) is securely coupled to the plate (FIG. 1, 102).

As depicted in FIG. 4, the docking station (106) may include multiple auxiliary ports (110). For simplicity in FIG. 4, just one auxiliary port (110) is indicated with a reference number. The auxiliary ports (110) allow auxiliary components to be attached to a docking station (106). That is, when a computing device (416) is inserted in the docking station (106), the auxiliary components are electrically connected to the computing device (416). In other words, the docking station (106) routes electrical signals from auxiliary components attached to the auxiliary ports (110) to the computing device (416) attached to the computing device port (FIG. 1, 108).

The auxiliary ports (110) may include any number and variety of connections. The auxiliary ports (110) may include ports that are unique to particular auxiliary components. For example, an input battery port may be unique to a particular type of battery that provides power to the computing device (416). Another example of an auxiliary port (110) that may be unique to the auxiliary component is a cable port to provide power from the computing device (416) to a head-mounted enhanced reality display. Other examples of auxiliary ports (110) that may be unique to an auxiliary component include an enhanced reality controller port and a data port for the head-mounted enhanced reality display.

In other examples, the auxiliary ports (110) may be usable by a number of auxiliary components. Examples of these multi-device ports include a universal serial bus (USB) port and a high-definition multimedia interface (HDMI) port. While FIG. 4 depicts a certain number and orientation of auxiliary ports (110) and while a few specific examples of types of auxiliary ports (110) have been provided, any number, orientation, and type of auxiliary port (110) may be used.

In some examples, an auxiliary port (110) includes a cable integrally formed with the docking station (106). In this example, the free-end of the cable may be plugged in directly to the auxiliary component.

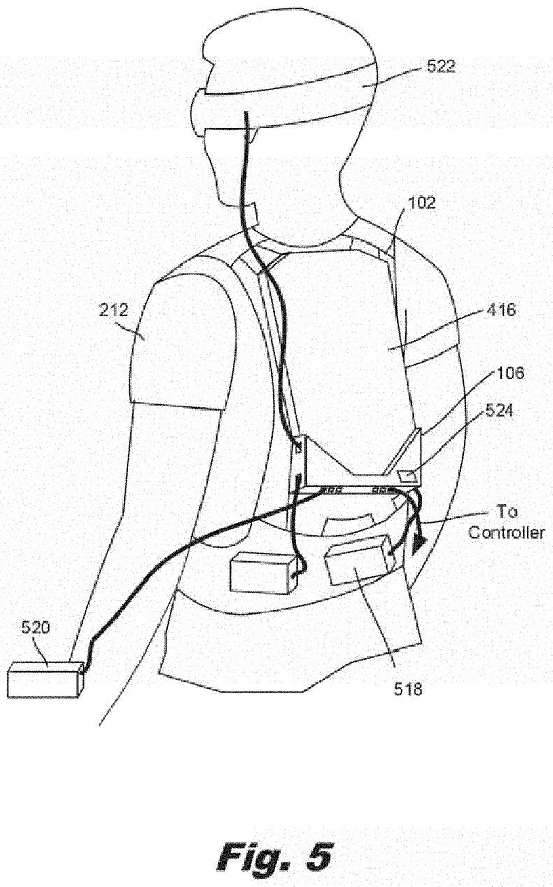

FIG. 5 is a back view of a user (212) wearing the wearable enhanced reality system, according to an example of the principles described herein. The wearable enhanced reality system includes the wearable computing device mount (FIG. 1, 100) which includes the harness (102), plate (FIG. 1, 104), and docking station (106). The system also includes the computing device (416) which may be an enhanced reality computing device (416) that generates the visual, auditory, and other sensory environments, detects user input, and manipulates the environments based on user input.

In this example, the wearable enhanced reality system also includes a number of auxiliary components which are connected via cables. For example, the enhanced reality system, may include a head-mounted enhanced reality display (522) to be worn by the user (212). The head-mounted enhanced reality display (522) may be communicatively coupled to the computing device (416) such that execution of computer readable program code by a processor associated with the computing device (416) causes a view of an enhanced reality environment to be displayed in the head-mounted enhanced reality display (522). In this example, the head-mounted enhanced reality display (522) implements a stereoscopic head-mounted display that provides separate images for each eye of the user, In some examples, the head-mounted enhanced reality display (522) may provide stereo sound to the user. In an example, the head-mounted enhanced reality display (522) may include a head motion tracking sensor that includes a gyroscope and/or an accelerometer. The head-mounted enhanced reality display (522) may also include an eye tracking sensor to track the eye movement of the user of the head-mounted enhanced reality display (522).

Another auxiliary component is a computing device (416) power supply (518). FIG. 5 depicts one power supply (518) with a reference number; however, any number of power supplies (518) may be present. In this example, the power supplies (518) are coupled to the docking station (106) via a multi-use, or unique, auxiliary connection and provide power to the computing device (416). That power is used to 1) generate the enhanced reality environment and 2) to provide power to other components such as the head-mounted enhanced reality display (522). An example of another auxiliary component is an enhanced reality controller (520) which may be held by the user (212) and used to interact with, and manipulate objects in the enhanced environment. While FIG. 5 depicts one controller (520), another controller (not shown) may also receive power from, and transmit data with the computing device (416) via the docking station (106).

Each of these auxiliary components may be coupled to the docking station (106) such that upon insertion of the computing device (416), data and power transfer are enabled to and from the different components. To use the computing device (416), a user (212) may simply insert the computing device (416) into, and establish a connection with, the docking station (106) that forms all the electrical connections. This allows a user (212) to use the enhanced reality system by making a single connection, i.e., computing device (416) to docking station (106), rather than making multiple connections between the computing device (416) and each auxiliary component.

In some examples, the auxiliary components may be attached to the harness (102) via quick release connections. For example, the head-mounted enhanced reality display (522) may include a cable that attaches to a cable on the shoulder strap so that it can be quickly attached and removed. In this example, the cable on the shoulder strap may remain attached to the docking station (106). Doing so simplifies putting the harness (102) on as a user puts the harness (102) on without the head-mounted enhanced reality display (522) attached to it, which may potentially result in the head-mounted enhanced reality display (522) being dropped on the ground.

As yet another example, the enhanced reality controllers (520) may include cables that attach to a cable on the waist strap so that they can be quickly attached and removed. In this example, the cable on the waist strap may remain attached to the docking station (106). Doing so simplifies putting the harness (102) on as a user puts the harness (102) on without the enhanced reality controllers (520) attached to it, which may potentially result in the enhanced reality controllers (520) being dropped on the ground.

Similarly, there may be docks for the computing device (416) power supplies (518) that allow them to be quickly attached and removed. The cables from the docks to the docking station (106) may remain attached. In each of these examples, the computing device (416) can be quickly attached and removed from the docking station (106) while the harness (102) is not being worn. The auxiliary components can be quickly attached to the harness (102) while the harness (102) is being worn without having to reach the docking station (106) or computing device (416).

In some examples, data and power transfer may be facilitated even when the computing device (416) is not installed. For example, the docking station (106) could be connected to a separate power supply and would then transfer that power to the power supplies (518), i.e., batteries, to charge them, even when the computing device (416) is not installed. It may also be desirable to drive power to various accessories, such as a wireless network card, powered USB ports, or global positioning systems among others. The docking station (106) itself may also be supplied with power, for example to perform updates received over the wireless network, even when a computing device (106) is not present. As yet another example, a user (212) may desire to charge controllers (520).

As described above, the mechanical fasteners (FIG. 3, 314) provide a physical coupling of the computing device (416) to the plate (FIG. 1, 104) and docking station (106). In some examples, a retainer of the docking station (106) may also provide this function. That is, a retainer of the docking station (106) may retain the computing device (416) in electrical connection with the docking station (106). In this example, the docking station (106) may include an ejection device (524), such as a mechanical release that disengages the retainer such that the computing device (416) can be removed from the mount (FIG. 1, 100).

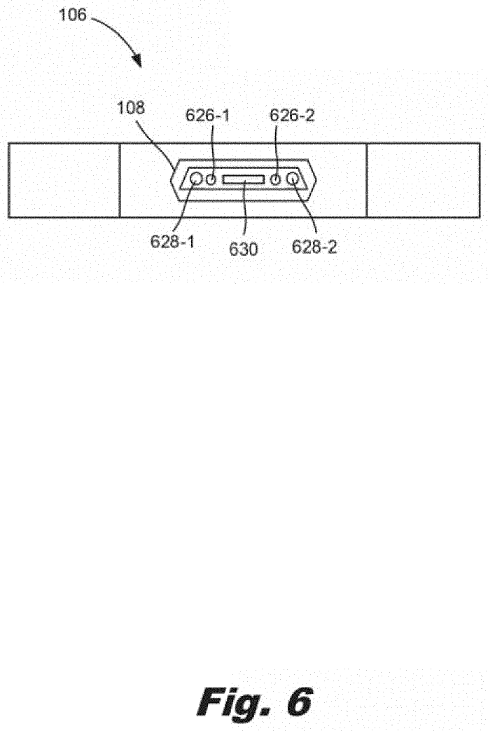

FIG. 6 is a top view of the docking station (106) of the wearable computing device mount (FIG. 1, 100), according to an example of the principles described herein. As described above, the docking station (106) includes a computing device port (108) that receives and retains the computing device (FIG. 4, 416). Specifically, the computing device port (108) includes a recess into which an electrical connector of the computing device (FIG. 4, 416) is inserted. Upon insertion, the electrical connector of the computing device (FIG. 4, 416) aligns with an electrical interface (630) of the docking station (106). That electrical interface (630) includes electrical leads routing data and/or power to the various auxiliary ports (FIG. 1, 110). The computing device port (108) may include locating pins (626-1 626-2) or interlocking slides to align the computing device (FIG. 4, 416) to the docking station (106). For example, the locating pins (626) may be protrusions that are inserted into corresponding recesses in the housing of the computing device (FIG. 4, 416).

The computing device port (108) may also include retainers (628-1, 628-2) such as clips, or hooks that interface with the computing device (FIG. 4, 416) to ensure the electrical interface (630) and electrical connector remain in contact during use. As described above, the ejection device (FIG. 5, 524) upon activation may disengage these retainers (628-1, 628-2) such that the computing device (FIG. 4, 416) may be removed.

In summary, using such a wearable computing device mount 1) improves immersion in the enhanced environment by allowing unimpeded movement of a user while interacting with the enhanced environment, 2) enhances the efficiency of use of an enhanced reality system by reducing the time between content creation and content viewing; and 3) simplifies the setup for the enhanced reality system. However, it is contemplated that the devices disclosed herein may address other matters and deficiencies in a number of technical areas.

The preceding description has been presented to illustrate and describe examples of the principles described. This description is not intended to be exhaustive or to limit these principles to any precise form disclosed. Many modifications and variations are possible in light of the above teaching.

What is claimed is:

1. A wearable computing device mount comprising;
a harness wearable by a user;
a plate attached to the harness, wherein a computing device is selectively mounted to the plate via mechanical fasteners; and
a docking station coupled to the plate, the docking station comprising;
a computing device port to engage with an electrical connector of the computing device when mounted to the plate; and
an auxiliary port to receive an auxiliary component, wherein the docking station electrically couples the computing device with the auxiliary component.

2. The mount of claim 1, wherein the harness positions the plate on a back of the user when worn.

3. The mount of claim 1, wherein the docking station is selectively removable from the plate.

4. The mount of claim 1, wherein the docking station is integrally formed with the plate.

5. The mount of claim 1, wherein the docking station is disposed below the plate.

6. The mount of claim 1, wherein the auxiliary port comprises a cable integrally formed with the docking station, the cable to receive the auxiliary component.

7. The mount of claim 1, wherein the auxiliary port receives auxiliary components selected from the group consisting of:
a battery to provide power to the computing device;
a cable to provide power from the computing device to a head-mounted enhanced reality display;
an enhanced reality controller; and
a head-mounted enhanced reality display.

8. A wearable computing system comprising:
a computing device; and
a wearable computing device mount comprising:
a harness wearable by a user;
a plate attached to the harness, wherein the computing device is selectively mounted to the plate via mechanical fasteners; and
a docking station coupled to the plate, the docking station comprising:
a computing device port to engage with an electrical connector of the computing device as the computing device engages with the mechanical fasteners of the plate.

9. The computing system of claim 8, wherein the computing device is an enhanced reality computing device to generate an enhanced reality environment.

10. The computing system of claim 8, wherein at least one of the plate and the docking station further comprise at least one of locating pins and interlocking slides to align the computing device to the docking station during installation.

11. The computing system of claim 8, wherein the docking station further comprises a retainer to retain the computing device in the computing device port during use.

12. The computing system of claim 11, further comprising an ejection device to release the computing device from the retainer.

13. A wearable enhanced reality system comprising:
an enhanced reality computing device to generate an enhanced reality environment;
a wearable computing device mount comprising:
a harness wearable by a user;
a plate attached to the harness, wherein the enhanced reality computing device is selectively mounted to the plate via mechanical fasteners; and
a docking station coupled to the plate, the docking station comprising:
a computing device port to:
establish an electrical connection with the enhanced reality computing device when mounted to the plate; and
engage with an electrical connection of the computing device as the computing device engages with the mechanical fasteners; and
multiple auxiliary ports, each to receive one of multiple auxiliary components, wherein the docking station electrically couples the enhanced reality computing device with the multiple auxiliary components; and
multiple auxiliary components comprising:
a head-mounted enhanced reality display; and
a computing device power supply.

14. The wearable enhanced reality system of claim 13, wherein the multiple auxiliary ports include ports selected from the group consisting of;
a universal serial bus (USB) port;
a high-definition multimedia interface (HDMl) port; and
an output power supply port.

15. The wearable enhanced reality system of claim 13, wherein the multiple auxiliary components further comprise an enhanced reality controller,
